(19) United States
(12) Patent Application Publication
(10) Pub. No.: US 2009/0327973 A1
(43) Pub. Date: Dec. 31, 2009

(54) PRESERVING A COMPLETE HISTORY OF A SET OF APPLICATION ACTIONS WHEN NON-LINEAR INTERACTIONS ARE PERMITTED

(75) Inventors: PUCCI LEE, HOLLY SPRINGS, NC (US); DINAH H. LIN, CARY, NC (US); PRATIK P. SHAH, DURHAM, NC (US); ZHENG ZHANG, APEX, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/111,560

(22) Filed: Apr. 29, 2008

(51) Int. Cl. G06F 3/048

(52) U.S. Cl. 715/854

(57) ABSTRACT

An action history maintains a set of ordered application actions associated with a user. A user interface of a software application can include a back control and a forward control, which utilize the action history. Specifically, the back control revokes a most recent action and the forward control reapplies a previously revoked action. Thus, the forward and backward controls change which page is rendered in the software application. Unlike traditional implementations, the invention maintains a complete set of actions within the action history in a non-linear context. That is, when a new action is inserted into a history from a non-terminal state (i.e., actions able to be reapplied are available upon a selection of the forward control) then the new action is inserted immediately after the current action. The historic actions are maintained in order after the new action in the action history.

### BACKGROUND OF THE INVENTION

The present invention relates to the field of action history handling and, more particularly, to preserving a complete history of a set of actions when non-linear interactions are permitted.

Software applications commonly record a history of user interactions for a number of reasons. For example, Web browsers typically include a forward and backward navigation button. A selection of a backward button takes a user backwards one Web page (or action) from a current point in a navigation action sequence. A selection of a forward button can take a user forward one Web page (or action) from a current point in the navigation action sequence. Many file explorers or navigators implement a similar history and contain forward and backwards buttons.

Situations exist where interactions based at least partially on a history are non-linear. For example, a browser user can navigate from Page1 to Page2 to Page3. At this point a user can select a backwards navigation button once, which causes a browser to display Page2. Then the user can navigate from Page2 to Page4, such as by entering a Uniform Resource Identifier (URI) for Page4 in a browser navigation pane. At this point, Page3 is no longer accessible via the forward and backward navigation buttons. That is, selecting the backwards navigation button once takes a user from Page4 to Page2 and another selection of the backwards button takes a user from Page2 to Page1 . From Page1 iterative selection of the forward button takes a user from Page1 back to Page2 and then from Page2 to Page4.

The reason for this behavior is that a navigation history available through navigation buttons is conventionally implemented as an ordered stack of actions. Actions are pushed to the top of the stack and popped from the stack in order. A current position in the stack is a reference point used when backwards navigation actions occur, so that “new actions” are popped on top of this current position in the history stack. Any previous actions that were “above” the current point in the history stack when the new action is added to the stack are lost. Thus, Page3 is “lost” when a non-linear interaction occurs in which the “new” action of adding Page4 to the stack intervenes and effectively replaces Page3 from its position in the history stack. Some browsers maintain an elaborate (and complete) navigation history that a user can show within a pop-up window. This navigation history can be implemented to maintain a “complete” history, which would in the scenario shown above still show Page3. Most users are unfamiliar with the pop-up window showing a browser history, so its inclusion is neither intuitive to most users or nor convenient. No known browser is capable of maintaining a complete history of actions for non-linear interactions that are available through forwards and backwards navigation buttons.

### BRIEF SUMMARY OF THE INVENTION

One aspect of the present invention can include a method, apparatus, computer program product, and system for utilizing action history. A history of user driven actions can be maintained for an application interface (e.g., a Web browser interface), where the interface includes a back control and a forward control that change application state of the underlying application (e.g., a Web browser) based upon the history of user driven actions. User input can be received through the interface, which causes the application to be adjusted to a certain state. In the described state, a selection of the forward control would result in an ActionA being applied by the application. Instead of selecting the forward control, however, an ActionB can be performed. An element for ActionB can be added to the history of user driven actions in a position immediately before an element for ActionA. ActionA can be retained in the history of user driven actions.

Another aspect of the present invention can include a method, apparatus, computer program product, and system for utilizing an action history for a software application. An ActionA can be performed by an application, which results in the application being placed in an ApplicationStateA. An ElementA can be added to an action history corresponding to ActionA. An ActionB can be performed by the application, which results in the application being placed in an ApplicationStateB. An ElementB can be added to an action history corresponding to ActionB. A selection of a back control can be received. Action B can be revoked so that the application is placed in ApplicationStateA. An ActionC can be performed so that the application is placed in ApplicationStateC. A section of a forward control can be received. ActionB can then be applied so that the application is placed in ApplicationStateB.

Still another aspect of the present invention can include a system for preserving interactive actions that includes a software application, an interaction history object, an interaction modification engine, and an interaction recording engine. The application can include a user interface that includes a back control and a forward control. The interaction history object can maintain a set of ordered elements, each element representing a user interaction with the application. The interaction modification engine can automatically revoke a past interaction responsive to a user selection of the back control. The revoked past interaction can be an interaction denoted by an element ordered immediately before a current position reference maintained for the interaction history object. Each time the interaction modification engine revokes a past interaction the current position reference can advances backward by one ordered element. The interaction modification engine can also reapply a previously revoked interaction denoted by an element ordered immediately after the current position reference maintained for the interaction history object. Each time the interaction modification engine reapplies the previously revoked interaction, the current position reference can advances forward by one ordered element. The interaction recording engine can detect a user interaction with the application and can responsively add an interaction element to the interaction history object for each detected user interaction. When the interaction recording element adds a new element and when one or more ordered elements are positioned in the interaction history object after the current position reference, the interaction recording engine can add the new element to the interaction history element at a point immediately after the current position reference. The one or more ordered elements can be shifted to a position immediately following the added new element. The current position reference can then be advanced forward by one ordered element.

### BRIEF DESCRIPTION OF THE SEVERAL VIEWS OF THE DRAWINGS

FIG. 1 is a schematic diagram of a system for preserving a complete history of a set of application actions when non-linear interactions are permitted in accordance with an embodiment of the inventive arrangements disclosed herein.

FIG. 2 is a diagram illustrating a set of application states for a set of application actions in which a complete action history is preserved in a non-linear context in accordance with an embodiment of the inventive arrangements disclosed herein.

FIG. 3 is a flow chart of a method for preserving an action history of application interactions in a non-linear context in accordance with an embodiment of the inventive arrangements disclosed herein.

### DETAILED DESCRIPTION OF THE INVENTION

The present invention is a modification of action history handling techniques used by software application, such as Web browsers. In the invention, an action history maintains a set of ordered actions associated with a user. An application interface of a software application can include a back control and a forward control, which utilize the action history. Specifically, the back control revokes a most recent action (i.e., displays a last viewed page) and the forward control reapplies a previously revoked action (i.e., displays a page existent before the back control was selected). Unlike traditional implementations, the invention maintains a complete set of actions within the action history in a non-linear context. That is, when a new action is inserted into a history from a non-terminal state (i.e., actions able to be reapplied are available upon a selection of the forward control) then the new action is inserted immediately after the current action. The historic actions are maintained in order after the new action in the action history. Thus, a sequence of Action1, Action2, BackControl, Action3, ForwardControl, results in Action2 being performed responsive to the ForwardControl selection. Conventionally Action2 would be unavailable via the forward control.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk—read only memory (CD-ROM), compact disk—read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

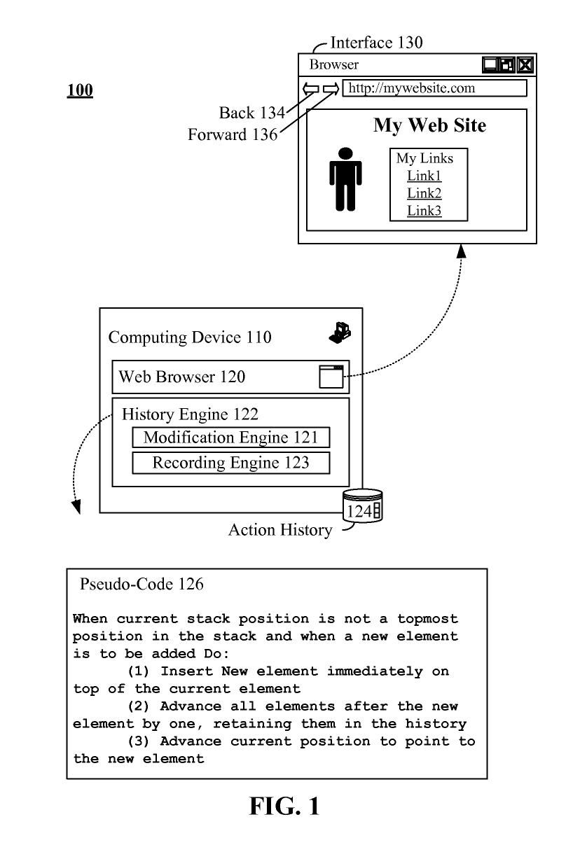

FIG. 1 is a schematic diagram of a system 100 for preserving a complete history of a set of application actions when non-linear interactions are permitted in accordance with an embodiment of the inventive arrangements disclosed herein. System 100 includes a computing device 110, which includes an application 120, a history engine 122, and a data store 124 maintaining an action history for interactions with application 120.

The application 120 can be any application (e.g., a Web browser, a rich internet interface (RII) application, a file explorer, a software development application such as ECLIPSE WORKBENCH, etc.) that includes a back control 134 and a forward control 136. A back control 134 can revoke one or more ordered actions to restore a previous application state. The forward control 136 can reapply a previously revoked action. For example, the application 120, shown by interface 130, can be a Web browser that uses forward 136 and back 124 controls to change which Web page is displayed in the browser based upon the action history.

History engine 122 can be implemented in software, firmware, and/or hardware to control a behavior of the back 134 and forward 136 controls. History engine 122 can cause a new action to be inserted into a middle of a set of ordered actions maintained in the data store 124.

As shown by pseudo-code 126, when a current position in a history is not a topmost position and when a new item is to be added, a series of programmatic action can occur. First, the new element corresponding to an action can be inserted immediately on top of a current element. On top referring to a position indicating a corresponding action occurred later in time than an ordered item an item positioned lower in the ordered history. Second, all elements after the new element in the ordered history can be advanced by one. This means these items are retained in history and available through a selection of the forward control 136. Third, a current position pointer for the ordered history can point to the new element.

The ordered history of actions can be maintained in data store 124 in a number of ways. For example, the action history can be implemented as a stack, as an ordered list, as an array, within a set of records having an associated time element used for ordering the actions, and using any other implementation scheme. Regardless of specific implementation choices (e.g., a data type, a language mechanism) which can vary from implementation to implementation, a software object, referred to as an interaction history object, can exist that maintains this ordered history. In one embodiment, the interaction history object can include a current position reference, which points to an item in the ordered action list that is “active,” meaning it is the last recorded action executed for the Web browser 120.

The history engine 122 can include one or more subcomponents, which perform functionally specific operations. In one embodiment, engine 122 can include an interaction modification engine 121 and an interaction recording engine 123.

The interaction modification engine 121 can automatically revoke a past interaction responsive to a user selection of the back control 134. The revoked past interaction can be denoted by an element ordered immediately before a current position reference maintained for the interaction history object. Each time the interaction modification engine 121 revokes a past interaction the current position reference can advance backward by one ordered element. The interaction modification engine 121 can also reapply a previously revoked interaction responsive to a user selection of the forward control 136. The reapplied interaction can be an interaction denoted by an element ordered immediately after the current position reference maintained for the interaction history object. Each time the interaction modification engine 121 reapplies the previously revoked interaction, the current position reference can advances forward by one ordered element.

The interaction recording engine 123 can detect a user interaction with the application 120 and can responsively add an interaction element to the interaction history object for each detected user interaction. When a new element is to be added, and when the current position reference shows that a current element is a last element of the interaction history element, then the new element can be added at the end and the current position reference can be advanced by one element. When a new entry for an action is entered and when a current position reference points to a non-terminal element, the engine 123 can implement programmatic actions as presented in pseudo-code 126.

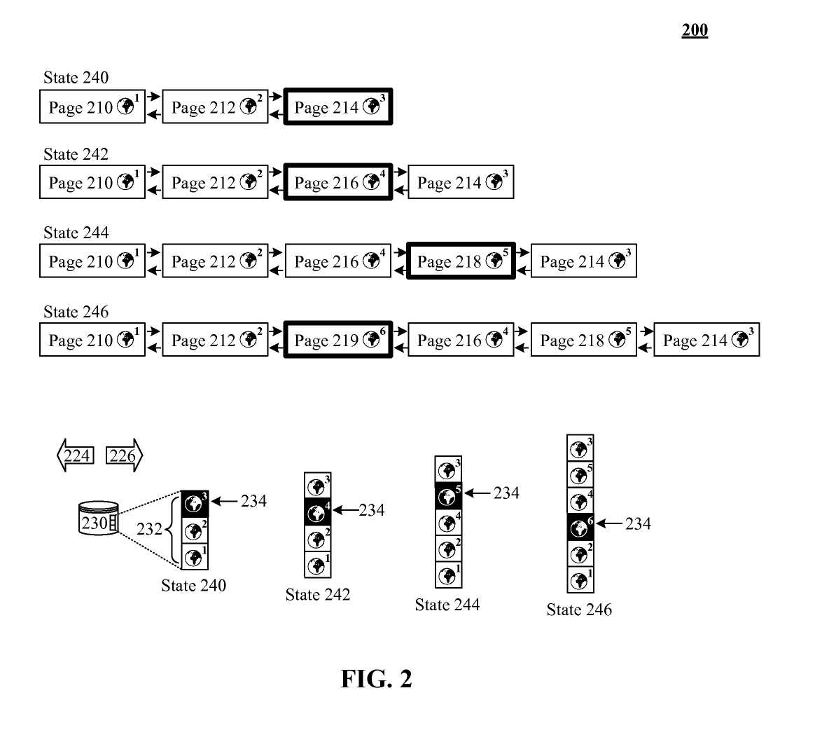

FIG. 2 is a diagram 200 illustrating a set of application states 240-246 for a set of application actions in which a complete action history is preserved in a non-linear context in accordance with an embodiment of the inventive arrangements disclosed herein. The states 240-246 shown in diagram 200 can occur within a context of system 100 or any system that maintains an action history and permits an ordered sequence of historical actions to be revoked and/or reapplied.

Diagram 200 shows a set of Web page 210-219, which are accessed through a browser. This is one contemplated embodiment for the present invention used for illustrative purposes only. Software applications other than Web browsers can use an application action history and can therefore implement the solution presented herein.

In the example shown by the diagram 200, as Web pages 210-219 are presented, a browser state changes. States 240-246 for the browser are shown. Further, ordered elements 232 corresponding to pages 210-219 contained in history objects 220-226 change. The elements 232 of the history objects 220-226 can be used to determine suitable programmatic actions to be performed when a forward 206 and a backward 204 control are selected. Arrows shown between the pages 210-219 for the various states 240-246 shows an effect of iteratively selecting the controls 204, 206. For example, in state 240, page 214 has focus. Selecting the back control 204 once results in page 212, selecting the back control 204 twice results in page 210. One forward control 206 selection from page 210 (based on state 240) result in page 212. A second forward control 206 selection results in page 214 again.

As shown, state 240 is achieved when page 210, page 212, and page 214 are accessed in order. Contents of history object 220 for state 240 include elements 232 for each of the three pages 210-214. The ordering of elements 242 can be Element1(e.g., page 210), Element2(e.g., page 212), and Element3 (e.g., page 214). Additionally, a current position reference 234 can point to page 214 (e.g., Element3), which would mean that the forward control 206 is disabled in state 240.

From state 240, a back control 204 selection can be made followed by an addition of page 216, which results in state 242. In state 242, the history object 222 contains an order of elements of Element1 (e.g., page 210), Element2 (e.g., page 212), Element4 (e.g., page 216), and Element3 (e.g., page 214). A current position reference 234 for state 242 can point to Element4. From state 242, page 218 can be accessed, which results in state 244.

In step 244, a browser can render page 218. The history object 244 can be changed to add Element5 (e.g., page 218) between Element4 and Element3. The current position reference 234 can be advanced forward one element, so that it points to Element5. From state 244, the back control 204 can be selected twice and a new page 219 can be added, which results in state 246.

In state 246, page 219 is rendered in the browser and the forward 206 and backward 204 controls are both active. The history object 226 can place Element 6 (e.g., page 219) after Element2 and before Element4. The current position reference 234 can point to Element6. A selection of back control 204 from page 219 in state 246 results in page 212 being displayed. A selection of forward control 206 from page 219 in state 246 results in page 216 being displayed.

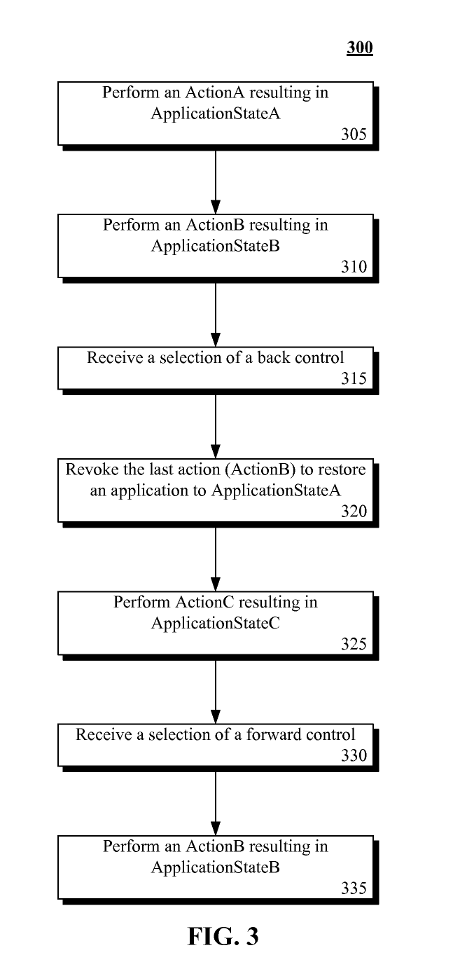

FIG. 3 is a flow chart of a method 300 for preserving an action history for application actions in a non-linear context in accordance with an embodiment of the inventive arrangements disclosed herein. The method 300 can be performed in a context of system 100 or any system that maintains an action history and permits an ordered sequence of historical actions to be revoked and/or reapplied.

Method 300 can begin in step 305, where a programmatic action, ActionA, can be performed that results in ApplicationStateA. The programmatic action can be an action executed within a computing device by an application based upon a user input. In step 310, another programmatic action, ActionB, can be performed that results in an ApplicationStateB. In step 315, a selection of a back control (e.g., a back navigation arrow button) can be received. This control causes the ActionB to be revoked, which restores the application to ApplicationStateA, as shown by step 320.

In step 325, another programmatic action, ActionC, can be performed that results in an ApplicationStateC. At this point, a selection of a forward control (e.g., a forward navigation arrow button), which was enabled, can be selected, as shown by step 330. In response to the forward control, ActionB can be performed, which results in an ApplicationStateB.

It should be emphasized that method 300 represents a change in conventional operations, where the performance of ActionC in step 320 would be considered a non-linear action, which would cause ActionB to become unavailable. That is, conventionally the forward control would be disabled at step 325 and it would be impossible to re-apply previously revoked ActionB through the forward control after step 325 was performed.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for preserving interactive actions comprising:
a software application comprising a user interface, said user interface comprising a back control and a forward control;
an interaction history object configured to maintain a plurality of ordered elements, each element representing a user interaction with the software application;
an interaction modification engine configured to automatically revoke a past interaction responsive to a user selection of the back control, wherein the revoked past interaction is an interaction denoted by an element ordered immediately before a current position reference maintained for the interaction history object, wherein each time the interaction modification engine revokes a past interaction the current position reference advances backward by one ordered element, wherein the interaction modification engine is configured to reapply a previously revoked interaction responsive to a user selection of the forward control, wherein the reapplied interaction is an interaction denoted by an element ordered immediately after the current position reference maintained for the interaction history object, wherein each time the interaction modification engine reapplies the previously revoked interaction the current position reference advances forward by one ordered element; and
an interaction recording engine configured to detect a user interaction with said software application and to responsively add an interaction element to the interaction history object for each detected user interaction, wherein when the interaction recording element adds a new element and when one or more ordered elements are positioned in the interaction history object after the current position reference, the interaction recording engine is configured to add the new element to the interaction history element at a point immediately after the current position reference, to order the one or more ordered elements to a position immediately following the added new element, and to advance the current position reference forward by one ordered element.

2. The system of claim 1, wherein the user interface comprises a graphical user interface (GUI), wherein the back interaction interface control is a previous page navigation control represented by a back arrow within the user interface, and wherein the forward interaction interface control is next page navigation control represented by a forward arrow within the user interface.

3. The system of claim 1, wherein the user interface comprises a voice user interface (VUI), wherein the back interaction interface control is a previous page navigation control selectable through a user provided speech input, and wherein the forward interaction interface control is next page navigation control selectable through a user provided speech input.

4. The system of claim 1, wherein the interaction history object is implemented as a stack of elements.

5. A method for utilizing an action history comprising:
performing an ActionA in a software application, which results in the software application being placed in an ApplicationStateA;
adding an ElementA to an action history corresponding to ActionA;
performing an ActionB in the software application, which results in the software application being placed in an ApplicationStateB;
adding an ElementB to an action history corresponding to ActionB;
receiving a selection of a back control;
revoking Action B so that the software application is placed in ApplicationStateA;
performing an ActionC so that the software application is placed in ApplicationStateC;
receiving a selection of a forward control;
determining ActionB is to be applied responsive to the selection of the forward control based upon elements in the action history; and
applying ActionB so that the software application is placed in ApplicationStateB.

6. The method of claim 5, wherein the wherein the software application comprises a graphical user interface (GUI), wherein the back control is a previous page navigation control represented by a back arrow within the graphical user interface, and wherein the forward control is next page navigation control represented by a forward arrow within the graphical user interface.

7. The method of claim 5, wherein the software application comprises a voice user interface (VUI), wherein the back control is a previous page navigation control selectable through a user provided speech input, and wherein the forward control is next page navigation control selectable through a user provided speech input.

8. The method of claim 5, wherein ActionA, ActionB, revocation of ActionB, ActionC, and an reapplication of ActionB is a sequence of temporally consecutive actions involving the software application and the action history, wherein no intervening actions involving the software application and the action history exist within the sequence of temporally consecutive actions.

9. The method of claim 5, wherein ActionA, ActionB, and ActionC are each different programmatic actions performed by the software application in response to at least one user interaction with a user interface of the software application, wherein ActionA, ActionB, and Action C are actions to navigate to a user designated page, and wherein the selection of the back control and the selection of the forward control are both user selections occurring within the user interface, and wherein ApplicationStateA, ApplicationStateB, and ApplicationStateC are each a state of the software application corresponding to a presentation of related page.

10. The method of claim 5, wherein the action history is an interaction history software object comprising an ordered set of elements, each element corresponding to a previously occurring action, wherein a current position reference is associated with the interaction history software object, wherein an element immediately advanced from the current position reference indicates an action that is to be applied upon a selection of the forward control, and wherein an element immediately before the current position reference indicates an action that is to be revoked upon a selection of the back control.

11. The method of claim 5, wherein said steps of claim 5 are performed by at least one machine in accordance with at least one computer program having a plurality of code sections that are executable by the at least one machine.

12. A method for utilizing action history comprising:
maintaining a history of user driven actions for a software application interface, wherein the software application interface comprises a back control and a forward control that change application state based upon the history of user driven actions;
receiving user input via the software application interface;
adjusting a state of a software application associated with the software application interface such that a selection of the forward control would result in an ActionA being applied by the software application;
performing an ActionB at the adjusted state of the software application; and
adding and element for ActionB to the history of user driven actions in a position immediately before an element for ActionA, while retaining the element for ActionA in the history of user driven actions.

13. The method of claim 12, wherein the wherein the software application interface comprises a graphical user interface (GUI), wherein the back control is a previous page navigation control represented by a back arrow within the graphical user interface, and wherein the forward control is next page navigation control represented by a forward arrow within the graphical user interface.

14. The method of claim 12, wherein the software application interface comprises a voice user interface (VUI), wherein the back control is a previous page navigation control selectable through a user provided speech input, and wherein the forward control is next page navigation control selectable through a user provided speech input.

15. The method of claim 12, further comprising:
immediately after ActionB is performed, receiving a user selection of the forward control; and
performing ActionA based upon the user selection of the forward control.

16. The method of claim 12, wherein ActionA and ActionB are each different programmatic actions performed by the software application in response to at least one user interaction with the software application interface, wherein ActionA and ActionB are actions to navigate to a user designated page.

17. The method of claim 14, wherein said steps of claim 14 are performed by at least one machine in accordance with at least one computer program having a plurality of code sections that are executable by the at least one machine.
